(19) United States
(12) Patent Application Publication
(10) Pub. No.: US 2006/0192419 A1
(43) Pub. Date: Aug. 31, 2006

(54) Adjustable back for high chair

(75) Inventors: Huang-Yi Cheng, Chiai County (TW); Yung-Shuen Lin, Chaiyi County (TW); Chi-Yung Lin, Kaohsiung City (TW)

Correspondence Address: BIRCH STEWART KOLASCH & BIRCH, PO BOX 747, FALLS CHURCH, VA, 22040-0747, US

(73) Assignee: Link Treasure Limited

(21) Appl. No.: 11/356,080

(22) Filed: Feb. 17, 2006

(30) Foreign Application Priority Data
Feb. 25, 2005 (TW) 094202967

(51) Int. Cl. B60N 2/02

(52) U.S. Cl. 297/354.12

(57) ABSTRACT

An adjustable back for high chair having a seat consists of a seat base pivotally connected to a seat back, and a plurality of positioners are disposed in an arc arrangement on both sides of the seat. The seat back is provided with an adjustable device which includes a handle. The handle can be manipulated by only one hand of the user to control the locking members indirectly via a linkage levers in order to engage or disengage the locking members from the positioners. This structure is easy for the user to adjust the seat inclination by only one hand and also reduces the cost with its simple components to be easily assembled.

### FIELD OF THE INVENTION

This invention relates to an adjustable back for high chair and; in particular, to a plurality of positioners which are disposed in a curve arrangement along two sides of arm rests of the seat. The locking members of the positioners can be either of fixable or releasable by manipulating a linkage lever of an handle which is connected to the seat back, and therefore the seat back of the high chair can be adjustable by the user.

### BACKGROUND OF THE INVENTION

High chairs are designed and convenient for feeding young children by their parents, or for seating the children comfortably during they having the meal together with adults. Generally, high chair consists of a supporting stand, a seat and a tray, wherein the seat is for accommodating the children and supported by the supporting stand; the tray is connected to the seat for placing food.

The seat of conventional high chairs are mostly made and designed of one-piece structure, and its seat back and seat base are connected fixedly to each other; therefore the seat back has only one angle which may not be always comfortable to the children of different sizes.

In order to comfort the children while they seating on the chair, another seat designed for high chair consists of a seat back and a seat base which are pivotally connected to each other; the angle between the back and the seat is adjustable by releasing a controlling devices from both sides of the seat; therefore thus could enhancing comfortable for seating the children. Nevertheless, it is not convenience for the user that they should adjust the angle at the both sides of the seat separately.

In addition, U.S. Pat. No. 6,398,304 to Chen et al., entitled “Highchair with an improved seat angle adjustment mechanism” disclosed an additional adjustment mechanism of high chair for user to adjust the angle by only one hand, whereby the user can manipulate an operating member on the upper part of the seat back to release an adjustment mechanism under the seat base. Although it may be more convenient to the user, the components of the mechanism are quite complicated and very difficult to the producer to assemble as well as manufacture and also raising the cost for production of high chairs.

### SUMMARY OF THE INVENTION

The present invention is aimed to overcome the defects and further to solve the problems those are resulted from the above mentioned adjustable mechanism, and provides an easy adjustable structure for both the user and the producer. According to the present invention, a seat base is pivotally connected to a seat back, and a plurality of positioners are disposed in a curve arrangement along two sides of arm rests of the seat. An adjustable device is located at the seat back, wherein the adjustable device comprises an handle; the positioner is engaged and disengaged by actuating a linkage lever which controls locking members indirectly. It is convenience for the user to adjust the angle of the seat and also saving the cost with easy assembling components to the producer.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and, together with the description, serve to explain the principles of the invention.

FIG. 1 is an elevational side view of a high chair in accordance with the present invention.

FIG. 2 is a perspective view showing the detachment of the seat back and the seat of the high chair according to FIG. 1.

FIG. 3 is an exploded perspective view of the adjustable back in accordance with the present invention.

FIG. 4 is a schematic view showing the movement of the adjustable back in accordance with the present invention.

FIG. 5 is a side view showing another movement of the adjustable back in accordance with the present invention.

FIG. 6 is a schematic view showing the flexible memberss of the adjustable back in accordance with the present invention

### DETAILED DESCRIPTION OF THE PREFERRED EMBODIMENTS

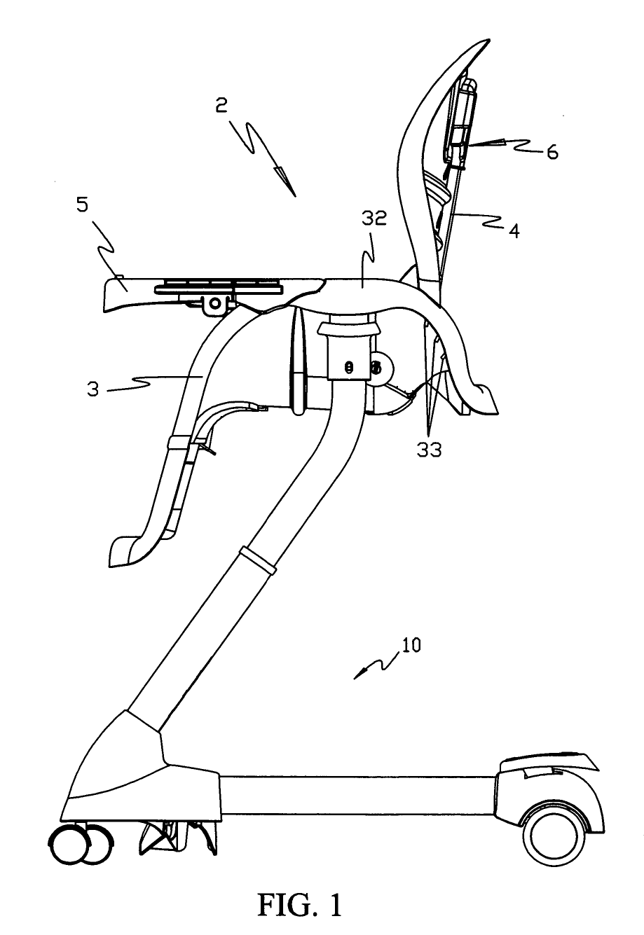

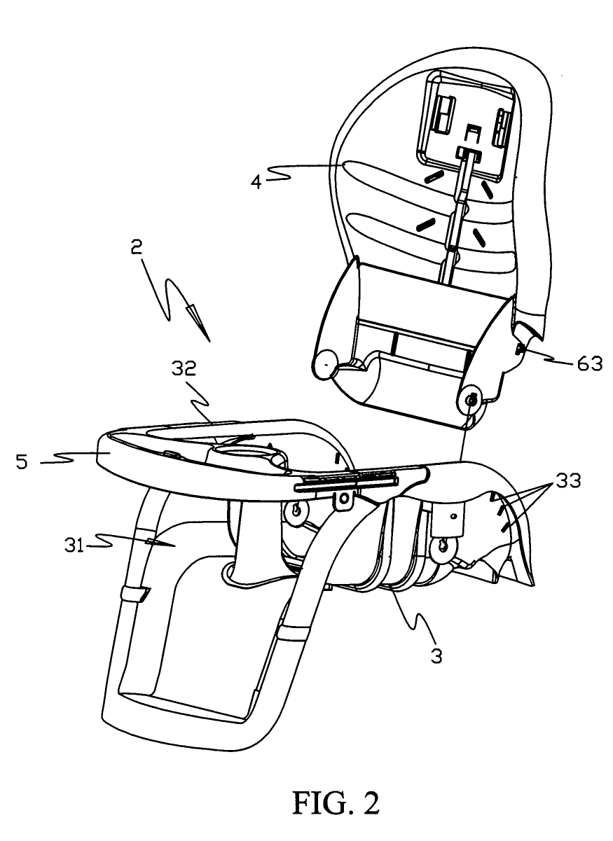

Referring to FIGS. 1 and 2, an adjustable back of high chair according to the present invention is provided to the users with an easy adjustment for the reclining angle of the seat back, therefore to accommodate young children with desirable angles. The adjustable back comprises a supporting stand 10 and a seat 2, wherein the height of the seat 2 can be adjusted and mounted on the supporting stand 10. The seat 2 includes a seat base 3 and a seat back 4.

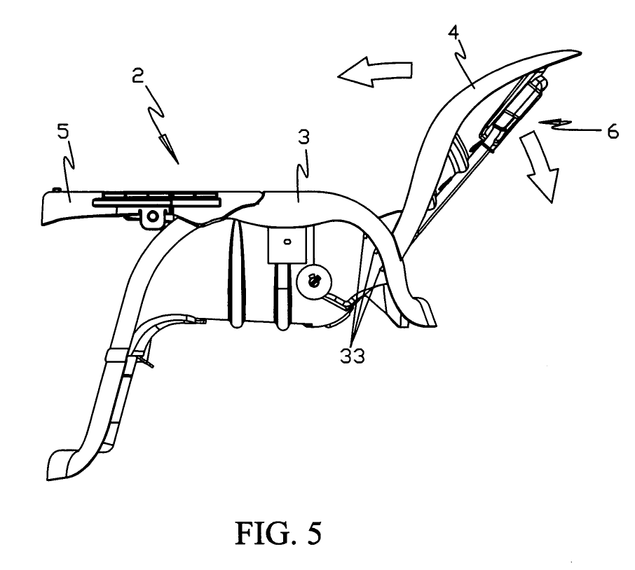

The seat base 3 is connected fixedly to the supporting stand 10, the seat base 3 consists of a seating portion 31 and the arm rests 32 on two sides of the seat 2. The arm rests 32 is provided with a food tray 5 for the children, and a plurality of positioners 33 are arranged curve behind the arm rests 32 of the seat base 3. Now please refer to the FIG. 5, the positioners can either be a plurality of grooves or indents.

The seat back 4 is pivoted to the seat base 3 by its lower end, and can be maintained against the seat 3 with different angles for the children to recline on the seat 2.

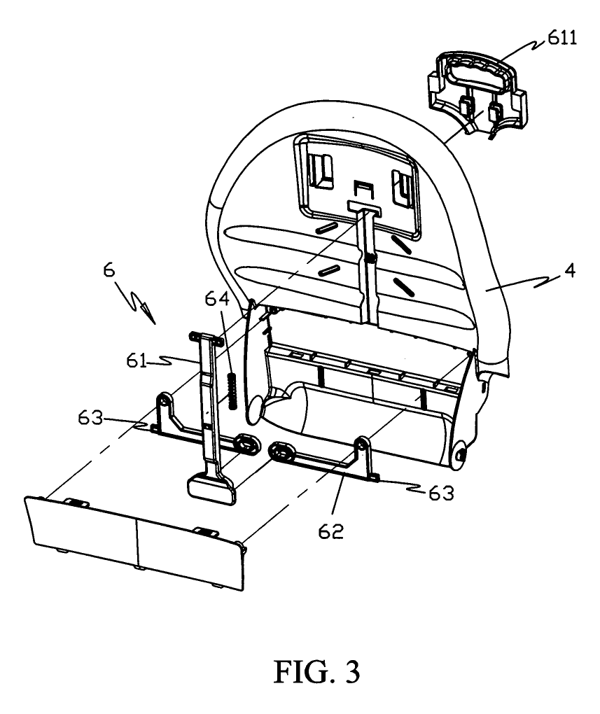

Further referring to FIGS. 3, 4 and 5, showing an adjustable device 6 is movable mounted on the seat back 4 and includes a handle 61, a pair of linkage levers 62 and a spring 64. The handle 61 is mounted on the seat back 4 and movable vertically and; the handle. Preferably, the handle 61 further comprises a grip 611 for easy manipulation. For easy to assemble, the handle 61 can alternatively separated from the grip 611, and the pair of linkage levers 62 are transversely rotatable and pivotally connected to the lower end of the handle 61, wherein the end of the linkage levers 62 are provided with locking members 63 which operates in coordination with the positioners 33. The locking members 63 can be as one-piece to the linkage levers 62 in accordance with the present invention.

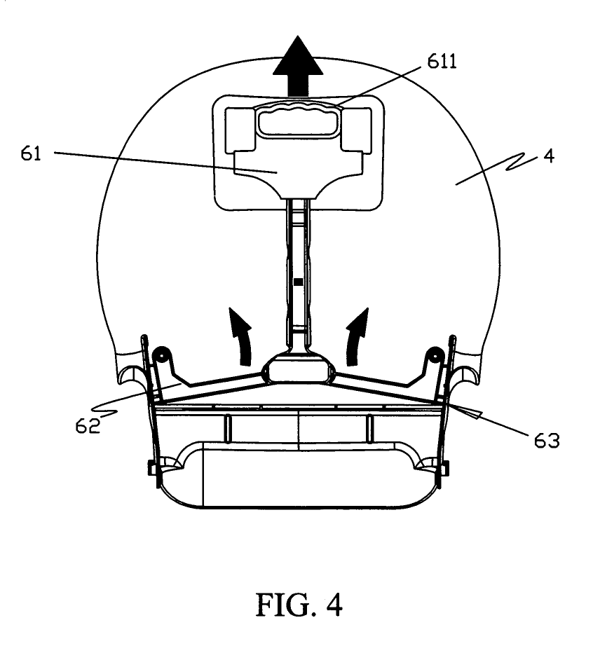

Normally, the locking members 63 is maintained in an engaged status with the positioners by the spring 64 which is disposed between the adjustable device 6 and the seat back 4; therefore a incline angle is formed rigidly between the seat back 4 and the seat base 3. Refer to FIGS. 4 and 5, while the user intends to adjust the angle of the seat back 4, the handle 61 can be pulled and propelled the linkage levers 62 to rotate; the locking members 63 at the end of the linkage levers 62 is disengaged from the positioners 33, the seat back 4 is then rotated to a inclined desirable angle. The simple and easily assembled structure is convenience for the user to adjust the incline of the seat back 4 by only one hand.

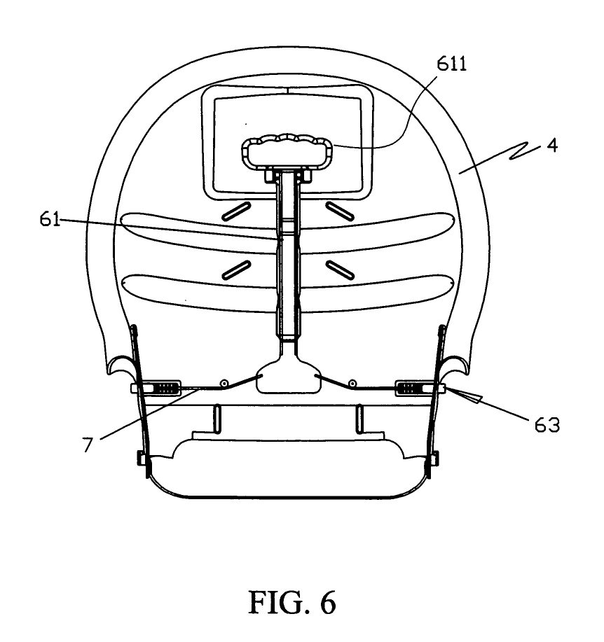

Furthermore, the additional feature of the present invention is that the end of the handle 61 can be connected to a pair of flexible members 7 as shown in FIG. 6, such as wires or soft plastic parts. The other end of the flexible members 7 is connected to the locking members 63; the locking members 63 is pulled by the flexible members 7 via manipulating the handle 61 and disengaged from the positioners 33.

While the invention has been described by way of example and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A adjustable back for high chair to adjust the inclination of a seat back, comprising:
a seat base including a seating portion and a pair of side arm rests, wherein the rear end of the arm rests is provided with a plurality of positioners in an arc arrangement;
a seat back pivotally connected to the seat base; and
an adjustable device movably mounted on the seat back and including a handle and a pair of locking members, wherein the handle is used to propel the locking members to engage or disengage from the positioners; the seat back and seat base are relatively rotated or positioned to each other with different inclination in order to properly accommodate young children.

2. The adjustable back for high chair of claim 1, wherein the positioners of the seat base are grooves.

3. The adjustable back for high chair of claim 1, wherein the handle includes a grip for user to pull up.

4. The adjustable back for high chair of claim 1, wherein the locking members are biased by a spring to engage in one of the positioners.

5. The adjustable back for high chair of claim 1, wherein the adjustable device further including a pair of linkage levers, which transversely and pivotally connected to the lower portion of the handle, whereby to propel the linkage levers into rotation via moving the handle.

6. The adjustable back for high chair of claim 5, wherein the locking members are formed in one-piece with one end of the linkage levers.

7. The adjustable back for high chair of claim 1, wherein the adjustable device is further comprising a pair of flexible members, which are connected between the handle and the locking members; the user can pull the handle in order to propel the locking members via the flexible members and disengage the locking members from the positioners.

8. The adjustable back for high chair of claim 7, wherein the flexible members are wires.

9. The adjustable back for high chair of claim 7, wherein the flexible members are soft plastic parts.
